(19) United States
(12) Patent Application Publication
(10) Pub. No.: US 2025/0331681 A1
(43) Pub. Date: Oct. 30, 2025

(54) Grill Grate Device

(71) Applicant: Stuart Whitten, Newnan, GA (US)

(72) Inventor: Stuart Whitten, Newnan, GA (US)

(21) Appl. No.: 19/190,867

(22) Filed: Apr. 28, 2025

Related U.S. Application Data
(60) Provisional application No. 63/640,466, filed on Apr. 30, 2024.

(51) Int. Cl. A47J 37/07

(52) U.S. Cl. CPC A47J 37/0786; A47J 2037/0795

(57) ABSTRACT

A grill grate device is provided. The device is comprised of a base, at least one fastener for removably attaching the base to a bottom grill grate, and at least one vertical attachment post extending upward from the base. The vertical post may be fixed or telescopic and includes at least one rotation point with a locking mechanism, allowing for angular and height adjustments. The lower end of the post may include a curved or angled bottom edge to provide a cantilever effect that enhances load distribution across the base. The upper grill grate attaches to the vertical post via reciprocal attachment points enabling secure yet detachable installation. The upper grill grate is suspended above the main grate and may be rotated laterally around the attachment point for repositioning.

### CROSS REFERENCE TO RELATED APPLICATION

The present application claims priority to, and the benefit of, U.S. Provisional Application No. 63/640,466, which was filed on Apr. 30, 2024, and is incorporated herein by reference in its entirety.

### FIELD OF THE INVENTION

The present invention relates generally to the field of grills. More specifically, the present invention relates to an attachable rotating upper grill grate for a grill. Accordingly, the present disclosure makes specific reference thereto. Nonetheless, it is to be appreciated that aspects of the present invention are also equally applicable to other like applications, devices, and methods of manufacture.

### BACKGROUND

Conventional grill designs often present significant challenges when it comes to maximizing cooking space and accessing food items during the cooking process. In particular, stationary upper cooking racks restrict access to the main grilling surface, which can complicate tasks such as turning food or managing cooking zones. Users frequently have to remove food or the rack entirely to reach items on the main grate, which introduces safety concerns and disrupts cooking efficiency. Furthermore, accessing heat sources such as charcoal or wood beneath the main grate is particularly difficult when upper racks are fixed in place. This issue is exacerbated in grills that feature hinged grates designed to allow for fuel replenishment, as these hinges become obstructed by rigid secondary racks. As outdoor cooking appliances continue to evolve, there remains a need for improved modularity, spatial efficiency, and ease of use in grill systems. A lack of adjustability and mobility in current multi-level grill designs limits versatility, particularly for users who cook multiple types of food simultaneously or who need to manage heat levels in real time. Therefore, there is a need for a device that not only allows vertical extension above the main grate but also enables lateral movement or swinging for easier access. Addressing these limitations can result in safer, more convenient, and more effective grilling experiences.

Therefore, there exists a long-felt need in the art for a grill grate device that provides additional cooking space without obstructing access to the main grill surface. There also exists a long-felt need in the art for a grill grate device that enables easy and quick repositioning of the upper grate for fuel access or food management. Moreover, there exists a long-felt need in the art for a grill grate device that securely mounts to various grill configurations while allowing adjustable vertical and angular placement.

The subject matter disclosed and claimed herein, in one embodiment thereof, comprises a grill grate device. The device is comprised of a base, at least one fastener for removably attaching the base to a bottom grill grate, and at least one vertical attachment post extending upward from the base. The vertical post may be fixed or telescopic and includes at least one rotation point with a locking mechanism, allowing for angular and height adjustments. The lower end of the post may include a curved or angled bottom edge to provide a cantilever effect that enhances load distribution across the base. The upper grill grate attaches to the vertical post via reciprocal attachment points enabling secure yet detachable installation. The upper grill grate is suspended above the main grate and may be rotated laterally around the attachment point for repositioning. The device may also be configured to fit within an enclosed grill space when the grill lid is closed. In some embodiments, a charcoal divider attaches to the lower grate to control heat zones, and multiple upper grates may be installed along the vertical post in a stacked configuration.

In this manner, the grill grate device of the present invention accomplishes all the forgoing objectives and provides a grill-attachable device that offers additional cooking space without interfering with access to the main grill surface, allowing users to reposition the upper grate through a swinging mechanism. The integration of a vertical attachment post with both fixed and telescopic configurations enables customizable height adjustments, while the locking rotation point permits stable angular positioning. The use of interchangeable or integrated fasteners ensures compatibility with various grill models and surface geometries. These features collectively solve the problems associated with stationary cooking racks and limited access to fuel sources, ultimately enhancing the efficiency, flexibility, and safety of grilling operations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a grill grate device. The device is comprised of a base configured to attach to a bottom grill grate using at least one fastener. The base is further comprised of at least one vertical attachment post extending upward. The post may be fixed perpendicularly or adjustable in angle through a rotation point, which includes at least one locking mechanism to secure the post orientation.

The lower end of the post may include a curved or angled bottom edge that provides a cantilever effect to distribute vertical load and reduce deflection. The post may be of fixed or telescopic height. A telescopic configuration allows vertical adjustment and includes a locking mechanism to maintain the selected height.

An upper grill grate is attached to the vertical post using reciprocating attachment points. These connections enable quick assembly while maintaining structural integrity. The upper grill grate is suspended above the bottom grill grate, with its angle adjustable via the rotation point. Multiple upper grill grates may be mounted in a stacked configuration on the post.

Both the bottom and upper grill grates may be configured in various geometric shapes with either uniform or non-uniform spacing to suit different cooking needs. The bottom grill grate may also include at least one hinge to provide access to charcoal without displacing the bottom grill grate.

The device is designed to be used with a grill having a closing lid and may be dimensioned to fit entirely within the grill when closed. Additionally, the device includes a charcoal divider attachable to the bottom grill grate. The divider allows separation of charcoal in either horizontal or front-to-back directions and may be connected with another divider to create angled configurations.

A method of use includes attaching the base to the bottom grill grate, positioning and locking the vertical post, adjusting the post height, attaching the upper grill grate, adjusting its orientation, and optionally stacking additional upper grates along the post.

Accordingly, the grill grate device of the present invention is particularly advantageous as it provides a grill-attachable device that offers additional cooking space without interfering with access to the main grill surface, allowing users to reposition the upper grate through a swinging mechanism. The integration of a vertical attachment post with both fixed and telescopic configurations enables customizable height adjustments, while the locking rotation point permits stable angular positioning. The use of interchangeable or integrated fasteners ensures compatibility with various grill models and surface geometries. These features collectively solve the problems associated with stationary cooking racks and limited access to fuel sources, ultimately enhancing the efficiency, flexibility, and safety of grilling operations. In this manner, the grill grate device overcomes the limitations of existing grills known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of a grill grate device of the present invention with the upper grill grate attached to the lower grill grate in accordance with the disclosed architecture;

FIG. 2 illustrates a bottom perspective view of one potential embodiment of a grill grate device of the present invention without a lower grill grate in accordance with the disclosed architecture;

FIG. 3 illustrates a side perspective view of one potential embodiment of a grill grate device of the present invention without a lower grill grate in accordance with the disclosed architecture;

FIG. 4 illustrates a side perspective view of a base of one potential embodiment of a grill grate device of the present invention in accordance with the disclosed architecture;

FIG. 5 illustrates a top perspective view of one potential embodiment of a grill grate device of the present invention without a lower grill grate in accordance with the disclosed architecture;

FIG. 6 illustrates a side perspective view of a divider of one potential embodiment of a grill grate device of the present invention in accordance with the disclosed architecture; and

FIG. 7 illustrates a flowchart of a method of using one potential embodiment of a grill grate device of the present invention in accordance with the disclosed architecture.

### DETAILED DESCRIPTION

The innovation is now described with reference to the drawings, wherein reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a grill grate device that provides additional cooking space without obstructing access to the main grill surface. There also exists a long-felt need in the art for a grill grate device that enables easy and quick repositioning of the upper grate for fuel access or food management. Moreover, there exists a long-felt need in the art for a grill grate device that securely mounts to various grill configurations while allowing adjustable vertical and angular placement.

The present invention, in one exemplary embodiment, is comprised of a grill grate device. The device is comprised of a base configured for attachment to a bottom grill grate using at least one fastener. The base is further comprised of at least one vertical attachment post extending upward. The post may be oriented perpendicularly or be adjustable in angle through a rotation point that includes at least one locking mechanism to secure the selected orientation.

The lower end of the post may include a curved or angled bottom edge that produces a cantilever effect to help distribute vertical load and reduce deflection. The post may be either fixed in height or telescopic. A telescopic configuration allows for height adjustment and includes a locking mechanism to secure the selected height.

An upper grill grate is connectable to the vertical post through reciprocating attachment points. These attachment points permit quick assembly and disassembly while maintaining structural integrity. The upper grill grate is suspended above the bottom grill grate, with its angle adjustable via the rotation point. Multiple upper grill grates may be supported in a stacked arrangement along the post.

Both the bottom and upper grill grates may be configured in various geometric shapes and may feature either uniform or non-uniform grate spacing to accommodate different cooking needs. The bottom grill grate may also include at least one hinge to allow access to charcoal without requiring the removal of the grate.

The device is intended for use with a grill that includes a closing lid and may be dimensioned to fit entirely within the grill when the lid is closed. The device also includes a charcoal divider that attaches to the bottom grill grate. The divider allows charcoal to be separated in horizontal or front-to-back directions and may connect with an additional divider to form angled configurations.

The method of use includes attaching the base to the bottom grill grate, positioning and locking the vertical post, adjusting the post height, attaching the upper grill grate, setting its orientation, and optionally stacking additional upper grates along the post.

Therefore, the grill grate device is advantageous as a grill-mounted accessory that increases cooking space without obstructing access to the main grill surface. The ability to reposition the upper grate via a swinging mechanism, combined with height and angle adjustability of the vertical post, provides enhanced versatility. Interchangeable or integrated fasteners ensure adaptability to various grill types and surface geometries. These features address the limitations of stationary racks and restricted access to fuel sources, improving the efficiency, flexibility, and safety of grilling operations.

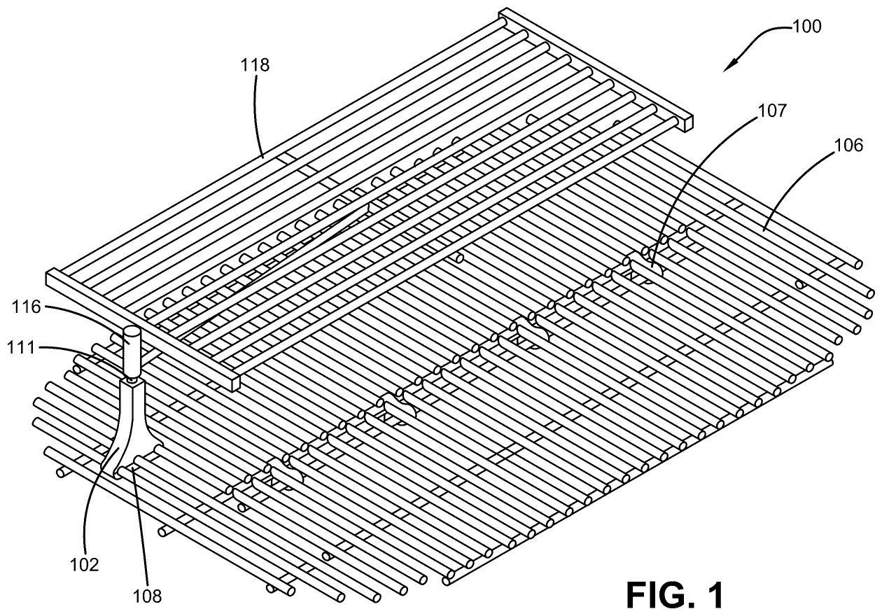

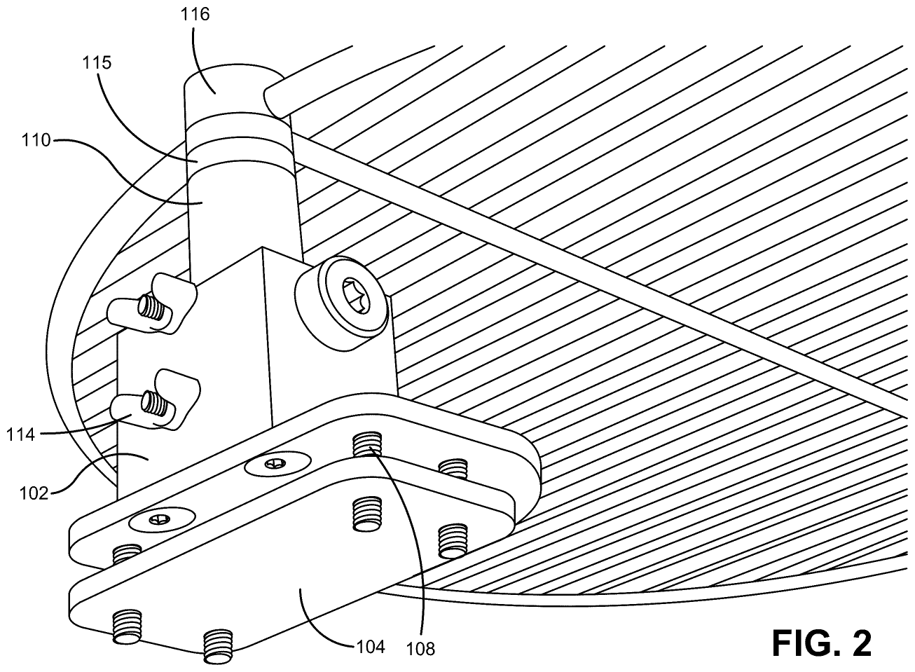

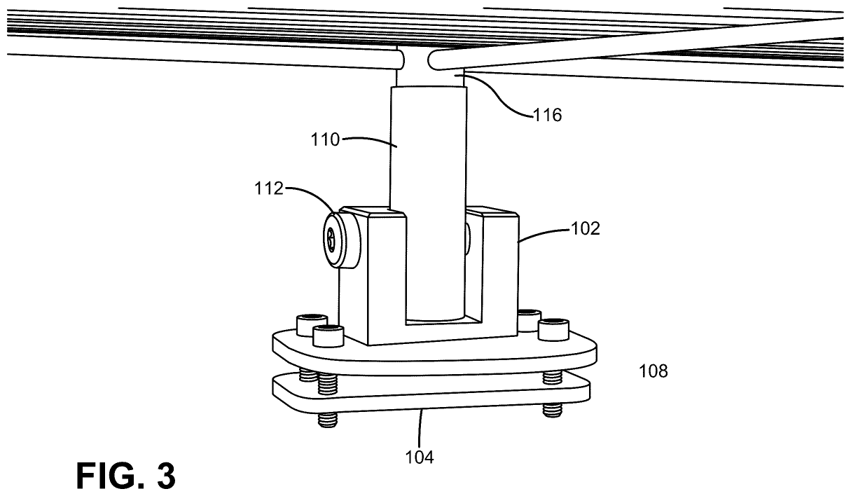

Referring initially to the drawings, the device 100 is comprised of a base 102. In one embodiment, at least one fastener 104 may attach to the base 102 to allow the base 102 to removably attach to a bottom grill grate 106 (and/or an existing grill gate of an existing grill), as seen in FIG. 1. In one embodiment, the fastener 104 may be comprised of an end plate that attaches to the base 102 via at least one fastener 108 such as but not limited to a threaded bolt, screw, or mechanical pin, as seen in FIG. 2, FIG. 3, and FIG. 1. In one embodiment, the fastener 104 is integrated into the base 102 itself, thereby eliminating the need for a separate attachment mechanism and providing a unified structural interface. In this embodiment, the fastener 104 may include, but is not limited to, a magnet, a clip, a clamp, a groove, etc. In various embodiments, the base 102 and/or fastener 104 may each be contoured or planar to correspond to the surface geometry of the bottom grill grate 106 or an existing grill grate. A contoured configuration may increase surface contact and mechanical stability when installed on irregular or curved grill surfaces.

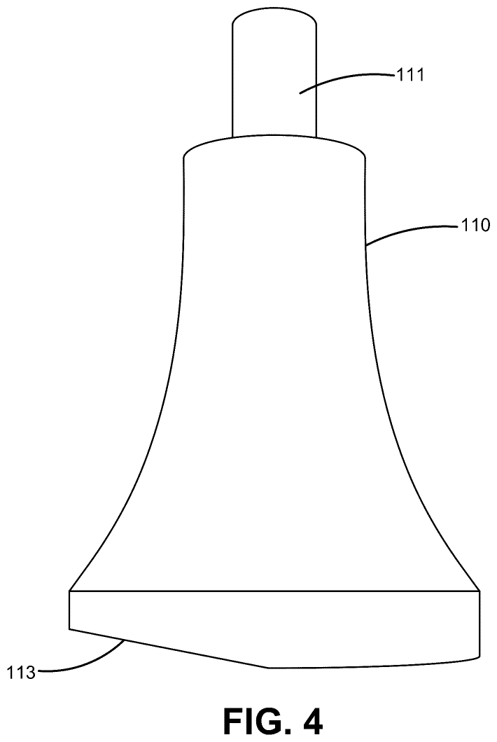

The base 102 is further comprised of at least one vertical attachment post 110,as seen in FIG. 1 and FIG. 4. The attachment post 110 may be oriented perpendicularly to the base 102 (at approximately 90 degrees), or may be angle-adjustable via at least one rotation point 112, as seen in FIG. 3, such as but not limited to a pivot joint, rotary coupling, knuckle assembly, etc. The rotation point 112 may include at least one locking mechanism 114, which may be comprised of but not limited to a compression clamp, threaded locking knob, detent pin, a ratcheting gear interface, etc. to secure the desired angular orientation of the post 110.

As seen in FIG. 4, in one embodiment the lower end of the post 110 may include a curved and/or angled bottom edge 113, which provides a cantilever effect that counterbalances vertical load from the upper grill grate 118. This cantilever effect may aid in distributing force across the base 102 and minimizing localized deflection or instability. The edge 113 may have any degree of curvature between 1 and 359 degrees and/or may form any angle between 1 and 179 degrees.

In one embodiment, the post 110 is of a fixed height. In another embodiment, the post 110 is telescopic, allowing for vertical height adjustability and includes at least one locking mechanism 115 such as but not limited to a twist-lock collar, spring pin, internal cam latch, etc., which maintains the selected post height during use. This telescoping feature enables the upper grill grate 118 to be positioned at various distances above the bottom grill grate 106 depending on cooking needs. In other embodiments, a fixed embodiment of the post 110 may differ in height.

At least one attachment point 116 of the upper grill grate 118 may removably or fixedly attach to an attachment point 111 of the vertical post 110. The attachment points 111 and 116 may be comprised of any reciprocating attachment types, such as but not limited to: male and female sockets, bayonet fittings, clevis and pin systems, latch hooks, threaded connection points, ball-and-socket joints, magnetic couplers, sliding dovetail interfaces, etc. These connections may permit quick assembly and disassembly, while ensuring structural integrity during cooking operations.

As a result, the upper grill grate 118 may be suspended above the bottom grill grate 106. Preferably, the top surfaces of the grates 106 and 118 are parallel. However, the angle of the upper grill grate 118 relative to the bottom grill grate 106 may be adjusted via the rotation point 112 and secured with the associated locking mechanism 114. In one embodiment, the height of the attachment point 116 may further govern the height of the upper grill grate 118 above the lower grill grate 106. In one embodiment, the post 110 receives a plurality of upper grill grates 118 in a stacked configuration.

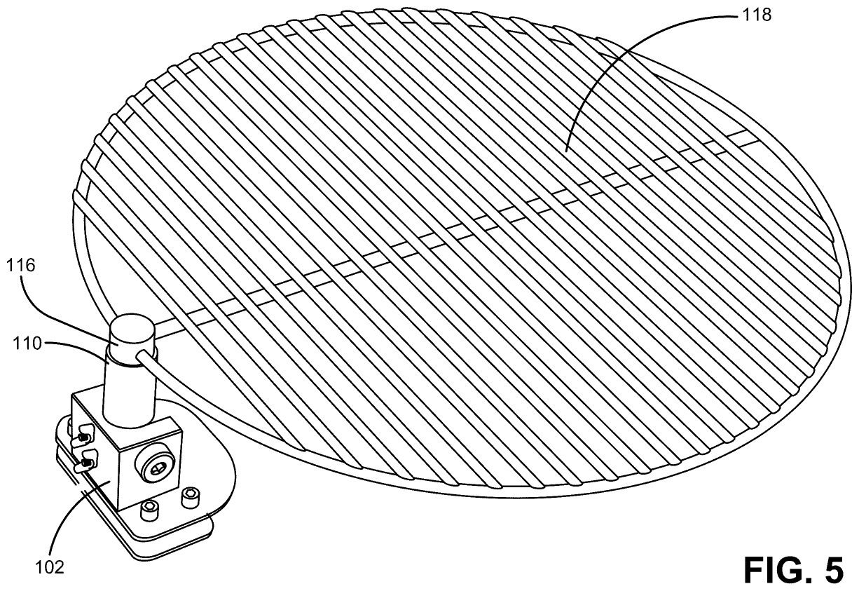

Both the bottom grill grate 106 and the upper grill grate 118 may be configured in any geometric shape, such as but not limited to circular (as seen in FIG. 5), square, rectangular, oval, or polygonal forms. The grate spacing for each grate may be uniform or non-uniform and may vary in dimensions to accommodate different types of food or cooking requirements.

In one embodiment, the bottom grill grate 106 may be comprised of at least one hinge 107, as seen in FIG. 1, which enables selective access to charcoal or heat source locations positioned beneath the grate 106. The hinge 107 may be located at the forward, rear, left-side, and/or right-side edge of the bottom grill grate 106. This hinged configuration allows a user to maintain the positioning of the grate 106 while replenishing or redistributing fuel sources during cooking. In the preferred embodiment, the device 100 has at least two hinges 107 that may be positioned anywhere on the grate 106.

As a result, a user may attach and suspend the upper grill grate 118 above the bottom grill grate 106 via the base 102 and the fastener 104, as seen in FIG. 1. The upper grill grate 118 may then be rotated about the attachment point 111 to reposition the cooking surface as needed. This device 100 may be used with a grill featuring a closing lid, and in such cases, the dimensions and geometry of the device 100 may be configured to fit entirely within the enclosed grill space when the lid is closed. The device 100 may also be used with any grill without a lid.

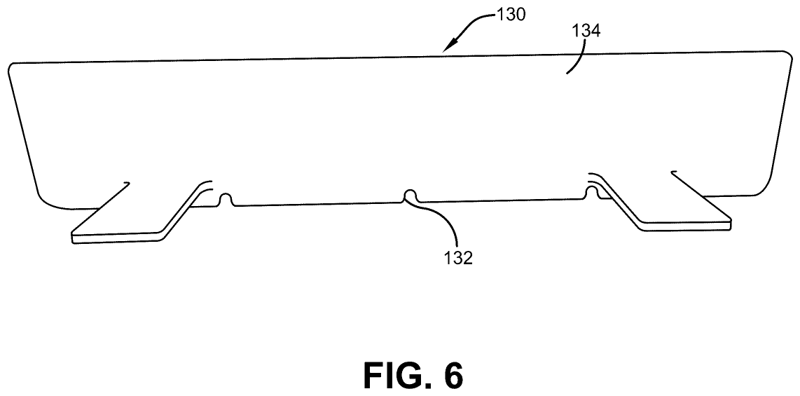

In one embodiment, the device 100 is also comprised of a charcoal divider 130, as seen in FIG. 6, that attaches to the bottom grill grate 106 via at least one fastener 132, such as but not limited to a notch. The divider 130 has a body 134 that allows for charcoal to be separated in a horizontal (i.e., left-to-right) fashion within the grill. However, the fasteners 132 may be positioned to also allow for front-to-back positioning of the divider 130. Further, two dividers 130 may also attach to one another via the fasteners 132 to form a plurality of angled configurations.

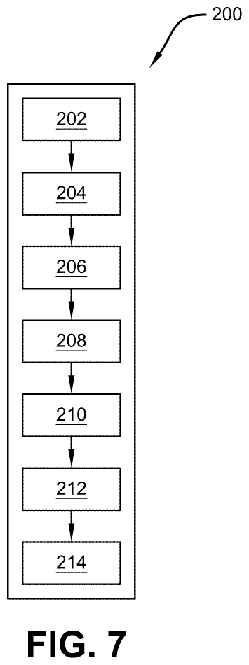

The present invention is also comprised of a method of using 200 the device 100, as seen in FIG. 7. First, a device 100 is provided comprised of a base 102, at least one fastener 104 configured to removably attach the base 102 to a bottom grill grate 106, and at least one vertical attachment post 110 extending upward from the base 102 [Step 202]. Then, the base 102 is removably attached to a bottom grill grate 106 (or an existing grill grate of a grill) using the fastener 104, wherein the fastener 104 may be selected from magnetic, mechanical, or integrated attachment configurations [Step 204]. Next, the post 110 is positioned perpendicularly or at a desired angle relative to the base 102 and secured using a rotation point 112 and associated locking mechanism 114 [Step 206]. Then, the height of the post 110 may be configured in one embodiment by either extending or collapsing a telescopic section of the post 110 and securing the desired height with the locking mechanism 115 [Step 208]. Next, an upper grill grate 118 is attached to an attachment point 111 of the post 110 using a reciprocal attachment point 116, such that the upper grill grate 118 is suspended above the bottom grill grate 106 [Step 210]. Then, the orientation of the upper grill grate 118 can be adjusted via rotation about the attachment point 111 and locked in place using the locking mechanism 114 [Step 212]. If desired, a plurality of upper grill grates 118 is attached in a stacked configuration along the vertical post 110 [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “grill grate device” and “device” are interchangeable and refer to the grill grate device 100 of the present invention.

Notwithstanding the forgoing, the grill grate device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the grill grate device 100 as shown in the FIGS. are for illustrative purposes only, and that many other sizes and shapes of the grill grate device 100 are well within the scope of the present disclosure. Although the dimensions of the grill grate device 100 are important design parameters for user convenience, the grill grate device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grill grate device comprising:
a base;
a fastener configured to attach to the base;
a vertical attachment post extending from the base, wherein the vertical attachment post further comprises a lower end having a curved bottom edge configured to provide a cantilever effect and a first attachment point;
an upper grill grate attached to the first attachment point of the vertical attachment post, wherein the first attachment point is configured to engage with a second attachment point of the upper grill grate.

2. The grill grate device of claim 1, wherein the vertical attachment post is comprised of a rotation point.

3. The grill grate device of claim 2, wherein the vertical attachment post is comprised of a first locking mechanism that secures the rotation point.

4. The grill grate device of claim 1, wherein the vertical attachment post is comprised of a telescopic post.

5. The grill grate device of claim 4, wherein the vertical attachment post is further comprised of a second locking mechanism.

6. The grill grate device of claim 1, wherein the first attachment point is comprised of a male socket.

7. The grill grate device of claim 1, wherein the second attachment point is comprised of a female socket.

8. A grill grate device comprising:
a lower grill grate;
a base;
a fastener configured to attach to the base, wherein the fastener secures the base to the lower grill grate;
a vertical attachment post extending from the base wherein the vertical attachment post further comprises a lower end having a curved bottom edge configured to provide a cantilever effect and a first attachment point;
an upper grill grate attached to the first attachment point of the vertical attachment post, wherein the first attachment point is configured to engage with a second attachment point of the upper grill grate.

9. The grill grate device of claim 8, wherein the lower grill grate is comprised of a first hinge and a second hinge.

10. The grill grate device of claim 8, wherein the vertical attachment post is comprised of a rotation point.

11. The grill grate device of claim 10, wherein the vertical attachment post is comprised of a first locking mechanism that secures the rotation point.

12. The grill grate device of claim 8, wherein the vertical attachment post is comprised of a telescopic post.

13. The grill grate device of claim 12, wherein the vertical attachment post is further comprised of a second locking mechanism.

14. The grill grate device of claim 8, wherein the first attachment point is comprised of a male socket.

15. The grill grate device of claim 8, wherein the second attachment point is comprised of a female socket.

16. A grill grate device comprising:
a lower grill grate;
a divider comprised of a first fastener that attaches the divider to the lower grill grate;
a base;
a second fastener configured to attach to the base, wherein the second fastener secures the base to the lower grill grate;
a vertical attachment post extending from the base wherein the vertical attachment post further comprises a lower end having a curved bottom edge configured to provide a cantilever effect and a first attachment point;
an upper grill grate attached to the first attachment point of the vertical attachment post, wherein the first attachment point is configured to engage with a second attachment point of the upper grill grate.

17. The grill grate device of claim 16, wherein the first fastener is comprised of a notch.

18. The grill grate device of claim 16, wherein the lower grill grate is comprised of a first hinge and a second hinge.

19. The grill grate device of claim 16, wherein the vertical attachment post is comprised of a telescopic post.

20. The grill grate device of claim 19, wherein the vertical attachment post is further comprised of a second locking mechanism.
